(19) United States
(12) Patent Application Publication
(10) Pub. No.: US 2002/0143589 A1
(43) Pub. Date: Oct. 3, 2002

(54) Supply chain optimization

(76) Inventor: Michael Abbott, Portola Valley, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/769,835

(22) Filed: Jan. 24, 2001

(51) Int. Cl. G06F 17/60

(52) U.S. Cl. 705/7; 273/297; 463/9; 463/25

(57) ABSTRACT

An apparatus, method, and computer program product. The method includes identifying a player in a supply chain, the player having one or more goals; identifying a decision in the supply chain, the decision having a plurality of possible actions each representing one or more other players in the supply chain and each having a payoff corresponding to each goal; and recommending one of the actions based on at least one of the historical behavior and commitments of the other players such that the payoffs are maximized for all players.

### BACKGROUND

The present invention relates generally to electronic commerce.

In conventional supply chains, businesses interact with each other to complete transactions that are mutually beneficial. Each business has different goals, and negotiates with other businesses to establish common ground for completing transactions. In addition, businesses may make commitments to other businesses in the supply chain in order to attain those goals.

Recent developments in networking technology have led to the flourishing of electronic commerce. Businesses increasingly rely on the Internet to complete transactions within the supply chain.

### SUMMARY

Many supply chains resemble the repeating games of game theory. In such supply chains, businesses come to know one another through repeated interactions, and operate according to this knowledge. For example, a business that exhibits a pattern of not meeting commitments in a repeat player supply chain will not survive long. In this way, repeat player supply chains are highly efficient mechanisms for doing business.

Recent advances in Internet technology have prompted a deluge of entrants into the growing electronic commerce arena. This arena is fairly new, and participants have had little time to acquire knowledge of each other. Thus the electronic commerce arena has yet to benefit from the efficiencies of the conventional supply chain.

In general, in one aspect, the invention features an apparatus, method, and computer program product. The method includes identifying a player in a supply chain, the player having one or more goals; identifying a decision in the supply chain, the decision having a plurality of possible actions each representing one or more other players in the supply chain and each having a payoff corresponding to each goal; and recommending one of the actions based on at least one of the historical behavior and commitments of the other players such that the payoffs are maximized for all players.

Particular implementations can include one or more of the following features. Each player is represented by at least one agent and identifying a player includes identifying a requesting agent representing the player. Recommending includes identifying an action for the requesting agent, the action identifying one or more customer agents with which the requesting agent should interact. Recommending further includes generating a decision model that describes the past behavior of competitor agents that compete with the requesting agent to interact with the customer; and selecting from the decision model past decisions that are relevant to the requesting agent. Recommending further includes combining the past decisions with a model of each competitor agent, thereby producing a payoff matrix for each competitor agent, each payoff matrix associating a value with each possible combination of customer agents. Recommending further includes selecting one of the competitor agents based on a cooperation index indicating the level of past cooperation between each competitor agent and the requesting agent. Recommending further includes selecting the combination of customer agents having the highest value in the payoff matrix associated with the selected competitor agent.

Advantages that can be seen in implementations of the invention include one or more of the following. The beneficial characteristics of a repeat player marketplace are brought to the electronic commerce arena. The system recommends actions to players that benefit the supply chain. Players that do not cooperate with other players are evolved out of the supply chain.

Further features and advantages of the present invention as well as the structure and operation of various implementations of the present invention are described in detail below with reference to the accompanying drawings. In the drawings, like reference numbers indicate identical or functionally similar elements.

### DESCRIPTION OF DRAWINGS

The present invention will be described with reference to the accompanying drawings.

FIG. 1 depicts a transaction manager interacting with two or more market participants in one or more supply chains.

FIG. 2 depicts the game optimization service.

FIG. 3 depicts a process by which competitors and customers become associated with one another.

FIG. 4 depicts a process for choosing an action for each agent subscribing to a decision.

### DETAILED DESCRIPTION

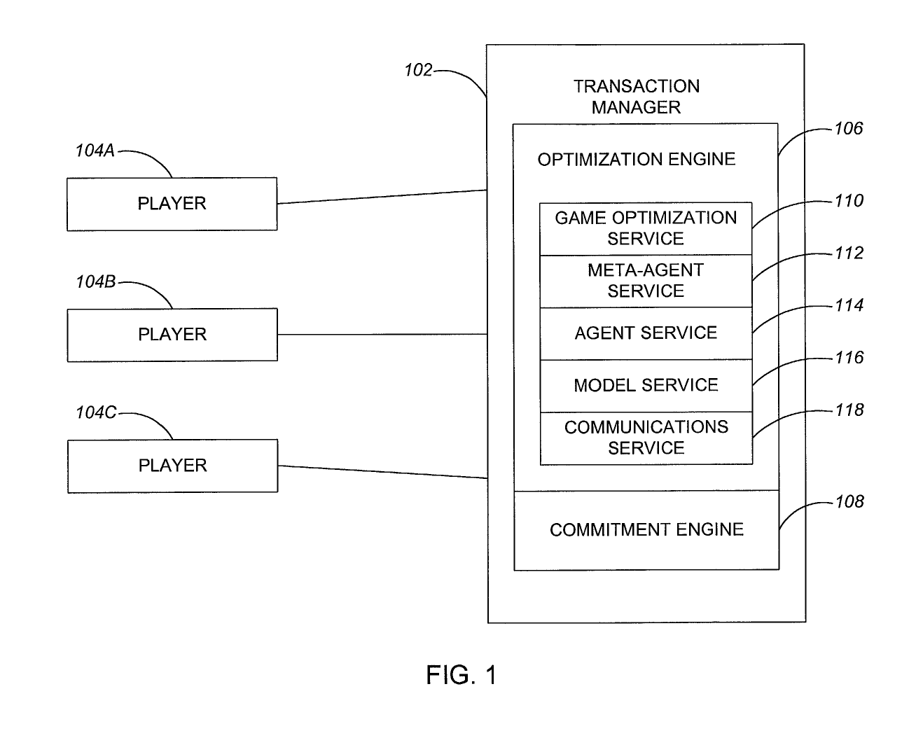

Referring to FIG. 1, a transaction manager 102 interacts with two or more market participants 104A, 104B, 104C, referred to herein as “players,” in one or more electronic commerce marketplaces, referred to herein as “supply chains” or “supply chain networks.” A player represents a business or a role of a business, such as buyer, supplier, or service provider.

From a game theory perspective, the interactions of the players in the supply chain form a repeating game, with a single transaction corresponding to a single decision in a game. The players interact with each other to effect transactions that are mutually beneficial. In game theory, this process is called “finding a Nash equilibrium” for the game. If there is a set of strategies with the property that no player can benefit by changing her strategy while the other players keep their strategies unchanged, then that set of strategies and the corresponding payoffs constitute the Nash Equilibrium.

In one implementation of the present invention, the repeating game is conducted so that the overall goals of the supply chain, referred to as the “game goals,” are met. When the game goals are set to coincide with the long-term interests of the majority of players, the game implements an efficient supply chain that is beneficial to both the players and the supply chain as a whole.

Such an arrangement is especially useful within an enterprise having business units that compete with one another for resources within the enterprise. For one competitor to succeed to the detriment of the enterprise would be inefficient. Within an enterprise, the game should be conducted to maximize the wealth of the enterprise. By setting the game goals appropriately, the game will accomplish this end.

This arrangement is also useful within any type of trading network or supply chain including those that are not managed by a single enterprise. In such supply chains, the game goal can be the overall revenue for the supply chain.

Referring to FIG. 1, the transaction manager 102 includes an optimization engine 106 and a commitment engine 108. The optimization engine includes several services.

A game optimization service 110 includes a multi-dimensional decision engine based on heuristics that executes a game in accordance with a game model. The game model is a matrix that identifies each game goal and a relative importance (that is, a weight) for each goal. The game goals can include metrics such as cost, time and quality. Each dimension in the decision engine represents a game goal. The game optimization service is described in detail below.

A meta-agent service 112 provides a layer to support inter-agent communication and interaction via various communications protocols (for example, RMI, HTTP, IIOP) as well as maintains the publish/subscribe relationships between various agents and models. An agent service 114 maintains agents for each player. A model service 116 maintains a model for each agent. Each agent model identifies the goals for the agent and the weight for each goal. If the agent has made commitments, the commitments are also described in the agent model.

A communications service 118 provides a layer for agents and models to interact in homogenous and heterogeneous environments. The communications layers may support multiple protocols (for example, TCP/IP, RMI, DCOM) that are present in Internet based systems.

The commitment engine generates a commitment index. The commitment engine thereby provides a mechanism to maintain key established relationships between agents that have been negotiated prior to a decision or selection. The commitment engine maintains a commitment index for all agents within the system as well as definitions for key elements of the commitment itself. The commitment indices are another variant provided into the selection action to provide for an optimal move selection.

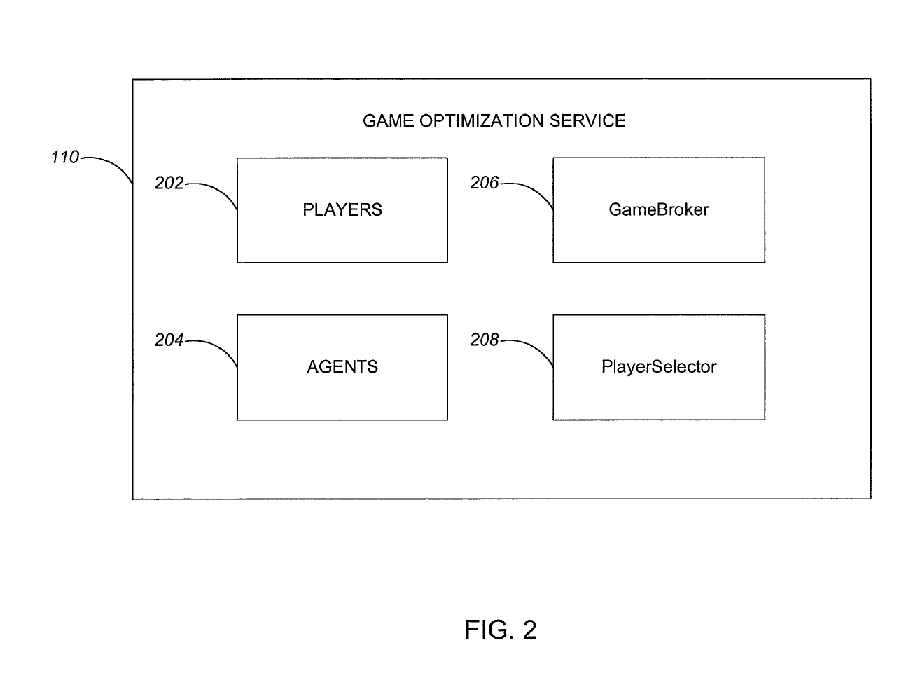

Referring to FIG. 2, the game optimization service 110 includes players 202, agents 204, a GameBroker 206 and a PlayerSelector 208.

Player

A player 202 represents a business or a role of a business. Each player includes the following methods.

The SubscribeGame method enrolls the player in a game and spawns an agent for each decision in the game.

The Publish method publishes the participation of the player into a particular game for participation.

The RebindModel method forces the player to retrieve a new copy of its model from the meta-agent layer.

The IsActive method flags if the player is an enabled game participant at that particular point in time.

Agent

A game includes an interaction between two or more players that subscribe to the game. A game includes one or more decisions. At each decision one or more players, referred to herein as “competitors,” attempt to interact with one or more other players, referred to herein as “customers.” The process by which competitors and customers become associated with one another is described in detail below.

At each decision, an agent 204 represents each player 202. Thus in a game having multiple decisions, a player will have multiple agents. An agent representing a competitor is referred to herein as a “competitor agent” (COA). An agent representing a customer is referred to herein as a “customer agent” (CUA).

Each agent has a model, referred to as an “agent model.” The agent model represents the actions available to the agent and the value of each action to each of the agent's goals. The agent model also describes any commitments made by the agent. The Agent includes the following methods.

The RequestAction method informs the GameBroker of the action chosen by an agent at a decision. Each agent chooses an action based on the action recommended by the PlayerSelector.

The Publish method publishes the participation of this agent into a particular game for participation.

The RebindModel method forces the agent to retrieve a new copy of its model from the meta-agent layer.

The IsActive method flags if the agent is an enabled game participant at that particular point in time.

GameBroker

The GameBroker 206 provides services to manage the overall repeating game of the supply chain network. The GameBroker manages all of the active players within the repeating game and publishes the actions that agents choose. Active players are those players that are participating in the current game or decision. The GameBroker also maintains and persists the states of the repeating game (referred to herein as the GameResult) in order for the participants to view the outcome of each game and affect future moves. The GameBroker includes the following methods.

The CreateGame method creates a game that models a transaction in the supply chain.

The PublishGame method announces the game to the players.

The RegisterAgent method adds a new agent to the game. New agents are added when a new player joins the game, or when a new decision in the supply chain is created.

The RequestMove method requests a recommendation of an action for each agent subscribing to a decision.

The PublishMoveSelection method announces the completion of one move. A move is the collection of actions selected by the agents at a decision. The move can be any move in the game, including the first and last moves. PublishMoveSelection also updates the agent models for the active players.

The SumGameStatus method measures the state of the repeating game after each completed game. This measurement is based upon the overall goals of the supply chain as reflected in the game model. The GameBroker uses the measurement to update the game model.

PlayerSelector

The PlayerSelector 208 is a service that determines an optimal interaction for a decision and recommends corresponding actions to the agent subscribing to that decision. In one implementation, the PlayerSelector recommends actions to players that maximizes the payoffs for all players. The PlayerSelector includes the following methods.

The FindPlayers method identifies all of the players that subscribe to a decision.

The SumAgentModels method aggregates the agent models for competitor agents at the decision to produce a decision model (DM). Thus DM is a model of past moves of the other players. DM provides a mechanism to assesses the historical behavior of other players in relation to the current goals of the agent. The DM shows how well competitors have contributed to the agent's goals in the past.

For example, the DM may show that a player has on average provided quality, time and cost values of 0.9, 0.5 and 0.4, respectively, to the agent. Here the DM is a three-dimensional representation of the outcomes of pas

The SelectAction method recommends an action to the RA. The action identifies agents with which the RA should interact. In one implementation, SelectAction considers the probabilities of other players taking particular actions.

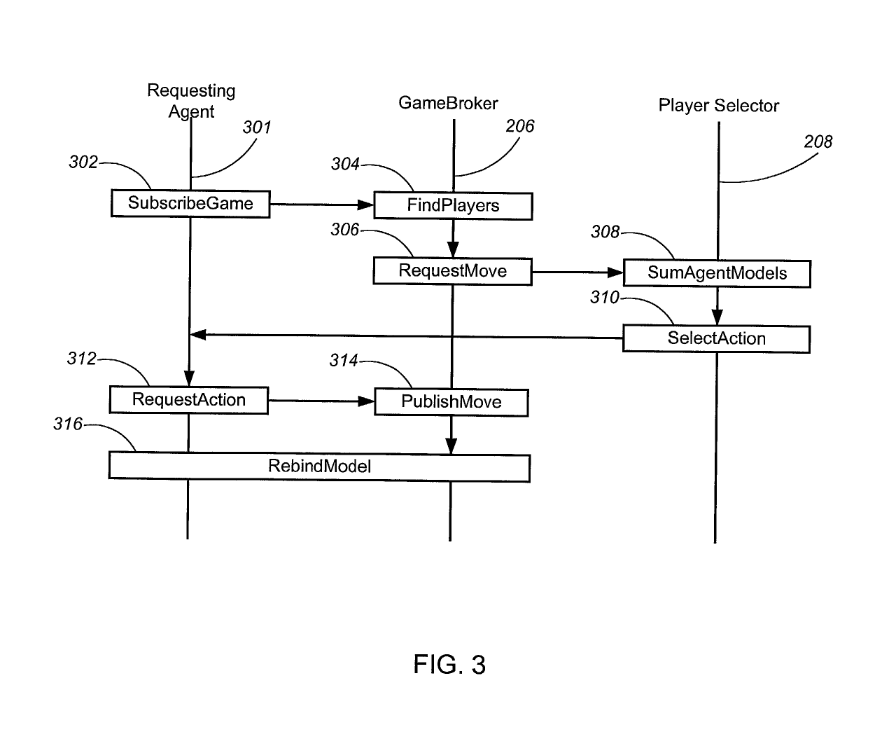

Referring to FIG. 3, a process by which competitors and customers become associated with one another is described below from the perspective of one of the competitors, referred to herein as the “requesting player.” An agent representing a requesting player is referred to herein as a “requesting agent” (RA).

Consider an example decision for an RA 301 involving two customer agents CUA₁ and CUA₂ and a competitor agent COA₁. Four actions are available to RA 301, as shown in Table 1. RA 301 can interact with CUA₁ only (action A₁), with CUA₂ only (action A₂), with both CUA₁ and CUA₂ (action A₃), or with neither CUA₁, nor CUA₂ (action A₄).

TABLE 1

| | |
|---|---|
| A₁ | CUA₁ only |
| A₂ | CUA₂ only |
| A₃ | CUA₁ and CUA₂ |
| A₄ | neither CUA₁ nor CUA₂ |

A portion of an agent model for competitor agent COA₁ is shown in Table 2. Each row represents a goal for the agent. Each column represents an action, such as those shown in Table 1. Each entry in the table represents the value of an action for a goal of the agent. The portion of the agent model shown in Table 2 represents a single game. If an agent has played in multiple games, the agent model will have a row for each goal for each game.

TABLE 2

| | A₁ | A₂ | A₃ | A₄ |
|---|---|---|---|---|
| COA₁ (Cost) | V_{C1} | V_{C2} | V_{C3} | V_{C4} |
| COA₁ (Time) | V_{T1} | V_{T2} | V_{T3} | V_{T4} |
| COA₁ (Quality) | V_{Q1} | V_{Q2} | V_{Q3} | V_{Q4} |

SubscribeGame

The SubscribeGame method enrolls the requesting player in the game and spawns an agent for each decision in the game, including RA 301 (step 302).

FindPlayers

When the game play reaches the decision corresponding to RA 301 (that is, when the GameBroker identifies the decision), the GameBroker invokes the FindPlayers method (step 304). The FindPlayers method identifies all of the players that subscribe to the decision, and identifies the agent for each player at the decision. Both competitors and customers are identified. In this example, FindPlayers finds customer agents CUA₁ and CUA₂ and competitor agents RA 301 and COA₁.

RequestMove

When all of the agents subscribing to the decision have been identified, the GameBroker invokes the RequestMove method (step 306). The RequestMove method requests from the PlayerSelector a recommendation of an action for each agent at the decision.

SumAgentModels

In response, the PlayerSelector invokes the SumAgentModels method (step 308). The SumAgentModels method aggregates the agent models for the competitor agents to produce a decision model (DM). In our example, because there is only one competitor, the DM is the same as the agent model for the competitor COA₁.

SelectAction

The SelectAction method chooses an action for each agent subscribing to the decision (step 310). In one implementation, the SelectAction method chooses an action for each agent such that the payoffs are maximized for all players.

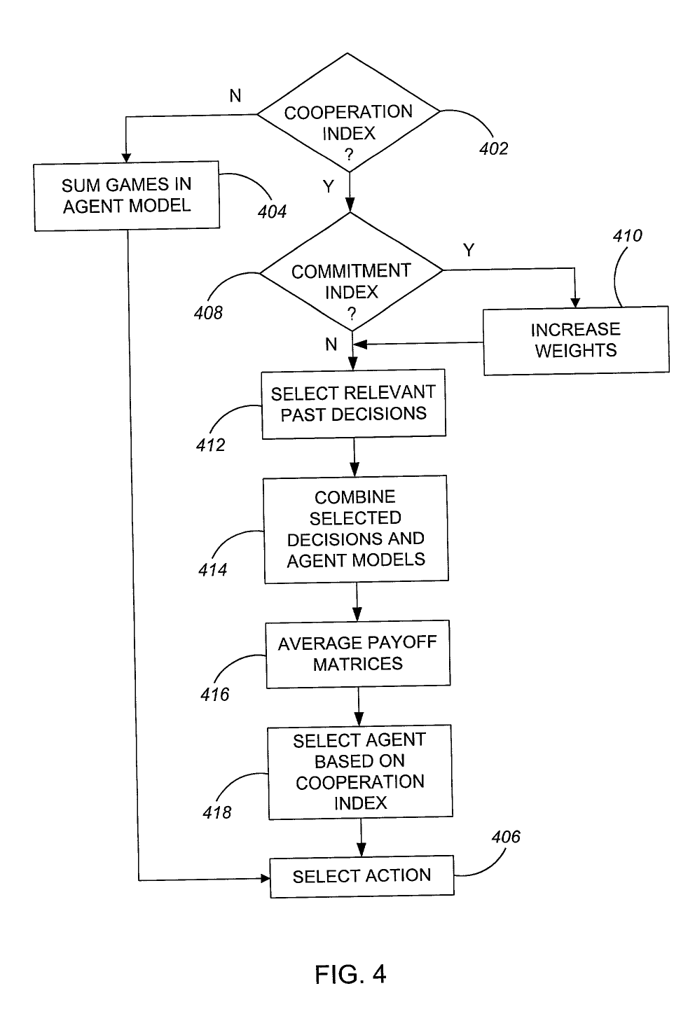

For example, the SelectAction method chooses (that is, identifies) an action for RA 301 based on the goals for RA 301, the agent model of RA 301, and the DM. Referring to FIG. 4, the method determines whether a cooperation index exists for RA 301 (step 402). The cooperation index represents the existence of a set of commitments that the RA 301 have established with other agents.

If no cooperation index exists for the RA 301 at the decision, then an action for the RA 301 is selected based on the model for the RA 301 (MRA) without reference to the DM. All of the games in the MRA are summed by creating new matrices that provide a set of values that incorporates all historical games (step 404). The action or element having the highest payoff value is chosen (step 406).

However, if a cooperation index exists for the RA 301 at the decision, both the MRA and the DM are used in selecting an action for the RA 301. The process determines whether a commitment index exists for RA 301 (step 408). The commitment index represents commitments made by other agents to the RA 301. If the cooperation index shows that an agent has made a commitment to the RA 301, the RA 301 increases the weights of that agent in the DM according to the level of commitment (step 410).

Next a function of the MRA and DM selects from the DM models of relevant past decisions (step 412). In one implementation, the function is the intersection of the MRA and DM. One type of relevant past decision includes past decisions where the RA 301 played. The selected models are aggregated to form a matrix GD that contains the outcomes of the relevant past decisions.

GD is combined with the models of each of the selected competitor agents CON to produce a set of matrices Q (step 414). For example, each matrix Q can be the cross-product of GD and a model of one of the competitor agents. Each matrix Q has the form shown in Table 3.

TABLE 3

| Q_{N} | CO_{N}, A₁ | CO_{N}, A₂ | CO_{N}, A₃ | CO_{N}, A₄ |
|---|---|---|---|---|
| RA, A₁ | Q_{1,1} | Q_{1,2} | Q_{1,3} | Q_{1,4} |
| RA, A₂ | Q_{2,1} | Q_{2,2} | Q_{2,3} | Q_{2,4} |
| RA, A₃ | Q_{3,1} | Q_{3,2} | Q_{3,3} | Q_{3,4} |
| RA, A₄ | Q_{4,1} | Q_{4,2} | Q_{4,3} | Q_{4,4} |

Each row in matrix Q_{N} represents an action for RA 301. Each column represents an action for CON. The matrices Q for each competitor agent are averaged to produce a payoff matrix S for each competitor agent. Each matrix S has the form shown in Table 4 (step 416).

TABLE 4

| S_{N} | CO_{N}, A₁ | CO_{N}, A₂ | CO_{N}, A₃ | CO_{N}, A₄ |
|---|---|---|---|---|
| RA, A₁ | S_{1,1} | S_{1,2} | S_{1,3} | S_{1,4} |
| RA, A₂ | S_{2,1} | S_{2,2} | S_{2,3} | S_{2,4} |
| RA, A₃ | S_{3,1} | S_{3,2} | S_{3,3} | S_{3,4} |
| RA, A₄ | S_{4,1} | S_{4,2} | S_{4,3} | S_{4,4} |

One of the competitor agents is selected based on the cooperation index for the requesting agent (step 418). Then the action within the matrix S for the selected competitor agent having the highest payoff value S for the RA 301 is chosen as the action for the RA 301 at the decision (step 406).

After choosing the actions for the decision, the PlayerSelector informs each agent of its decision.

RequestAction

Each agent chooses an action based on the action recommended by the PlayerSelector and informs the GameBroker of the action chosen (step 312).

PublishMove

The GameBroker publishes the actions selected by all of the agents at the decision and implements the actions chosen by the agents (step 314).

RebindModel

The GameBroker facilitates the rebinding of each agent to its model to reflect the results of the last completed game (step 316). Each entry in the agent model is updated according to equation (1).

V(goal)=1−[|agentgoal−playergoal|^{f}+|agentgoal−gamegoal|^{f}]×gameresult (1)

where f is the game priority of the relationship with the players, and can be linear or exponential. The GameResult is retrieved from the GameBroker, which maintains the historical interactions of all agents and the subsequent outcomes of they games that they participated in.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

While various implementations of the present invention have been described above, it should be understood that they have been presented by way of example, and not limitation. It will be apparent to persons skilled in the relevant art that various changes in form and detail can be placed therein without departing from the spirit and scope of the invention. Thus the present invention should not be limited by any of the above-described example implementations, but should be defined only in accordance with the following claims and their equivalents.

What is claimed is:

1. An apparatus comprising:
means for identifying a player in a supply chain, the player having one or more goals;
means for identifying a decision in the supply chain, the decision having a plurality of possible actions each representing one or more other players in the supply chain and each having a payoff corresponding to each goal; and
means for recommending one of the actions based on at least one of the historical behavior and commitments of the other players such that the payoffs are maximized for all players.

2. The apparatus of claim 1, wherein each player is represented by at least one agent and means for identifying a player comprises:
means for identifying a requesting agent representing the player.

3. The apparatus of claim 2, wherein means for recommending comprises:
means for identifying an action for the requesting agent, the action identifying one or more customer agents with which the requesting agent should interact.

4. The apparatus of claim 3, wherein means for recommending further comprises:
means for generating a decision model that describes the past behavior of competitor agents that compete with the requesting agent to interact with the customer; and
means for selecting from the decision model past decisions that are relevant to the requesting agent.

5. The apparatus of claim 4, wherein means for recommending further comprises:
means for combining the past decisions with a model of each competitor agent, thereby producing a payoff matrix for each competitor agent, each payoff matrix associating a value with each possible combination of customer agents.

6. The apparatus of claim 5, wherein means for recommending further comprises:
means for selecting one of the competitor agents based on a cooperation index indicating the level of past cooperation between each competitor agent and the requesting agent.

7. The apparatus of claim 6, wherein means for recommending further comprises:
means for selecting the combination of customer agents having the highest value in the payoff matrix associated with the selected competitor agent.

8. A method comprising:
identifying a player in a supply chain, the player having one or more goals;
identifying a decision in the supply chain, the decision having a plurality of possible actions each representing one or more other players in the supply chain and each having a payoff corresponding to each goal; and
recommending one of the actions based on at least one of the historical behavior and commitments of the other players such that the payoffs are maximized for all players.

9. The method of claim 8, wherein each player is represented by at least one agent and identifying a player comprises:
identifying a requesting agent representing the player.

10. The method of claim 9, wherein recommending comprises:
identifying an action for the requesting agent, the action identifying one or more customer agents with which the requesting agent should interact.

11. The method of claim 10, wherein recommending further comprises:
generating a decision model that describes the past behavior of competitor agents that compete with the requesting agent to interact with the customer; and
selecting from the decision model past decisions that are relevant to the requesting agent.

12. The method of claim 11, wherein recommending further comprises:
combining the past decisions with a model of each competitor agent, thereby producing a payoff matrix for each competitor agent, each payoff matrix associating a value with each possible combination of customer agents.

13. The method of claim 12, wherein recommending further comprises:
selecting one of the competitor agents based on a cooperation index indicating the level of past cooperation between each competitor agent and the requesting agent.

14. The method of claim 13, wherein recommending further comprises:
selecting the combination of customer agents having the highest value in the payoff matrix associated with the selected competitor agent.

15. A computer program product, tangibly stored on a computer-readable medium, comprising instructions operable to cause a programmable processor to:
identify a player in a supply chain, the player having one or more goals;
identify a decision in the supply chain, the decision having a plurality of possible actions each representing one or more other players in the supply chain and each having a payoff corresponding to each goal; and
recommend one of the actions based on at least one of the historical behavior and commitments of the other players such that the payoffs are maximized for all players.

16. The computer program product of claim 15, wherein each player is represented by at least one agent and instructions operable to cause a programmable processor to identify a player comprise instructions operable to cause a programmable processor to:
identify a requesting agent representing the player.

17. The computer program product of claim 16, wherein instructions operable to cause a programmable processor to recommend comprise instructions operable to cause a programmable processor to:
identify an action for the requesting agent, the action identifying one or more customer agents with which the requesting agent should interact.

18. The computer program product of claim 17, wherein instructions operable to cause a programmable processor to recommend further comprise instructions operable to cause a programmable processor to:
generating a decision model that describes the past behavior of competitor agents that compete with the requesting agent to interact with the customer; and
selecting from the decision model past decisions that are relevant to the requesting agent.

19. The computer program product of claim 18, wherein instructions operable to cause a programmable processor to recommend further comprise instructions operable to cause a programmable processor to:
combining the past decisions with a model of each competitor agent, thereby producing a payoff matrix for each competitor agent, each payoff matrix associating a value with each possible combination of customer agents.

20. The computer program product of claim 19, wherein instructions operable to cause a programmable processor to recommend further comprise instructions operable to cause a programmable processor to:
selecting one of the competitor agents based on a cooperation index indicating the level of past cooperation between each competitor agent and the requesting agent.

21. The computer program product of claim 20, wherein instructions operable to cause a programmable processor to recommend further comprise instructions operable to cause a programmable processor to:
selecting the combination of customer agents having the highest value in the payoff matrix associated with the selected competitor agent.
